(19) United States
(12) Patent Application Publication
(10) Pub. No.: US 2020/0380339 A1
(43) Pub. Date: Dec. 3, 2020

(54) INTEGRATED NEURAL NETWORKS FOR DETERMINING PROTOCOL CONFIGURATIONS

(71) Applicant: GENENTECH, INC., South San Francisco, CA (US)

(72) Inventors: Kim Matthew Branson, Redwood City, CA (US); Katherine Ann Aiello, San Francisco, CA (US); Ramsey Magana, South San Francisco, CA (US); Alexandra Pettet, South San Francisco, CA (US); Shonket Ray, South San Francisco, CA (US)

(21) Appl. No.: 16/884,336

(22) Filed: May 27, 2020

Related U.S. Application Data
(60) Provisional application No. 62/854,089, filed on May 29, 2019.

(51) Int. Cl. G06N 3/04; G06N 3/063; G06K 9/62

(52) U.S. Cl. CPC G06N 3/0454; G06K 9/6256; G06N 3/063; G06N 3/0445

(57) ABSTRACT

Methods and systems disclosed herein relate generally to systems and methods for integrating neural networks, which are of different types and process different types of data. The different types of data may include static data and dynamic data, and the integrated neural networks can include feedforward and recurrent neural networks. Results of the integrated neural networks can be used to configure or modify protocol configurations.

### CROSS-REFERENCE TO RELATED APPLICATIONS

This application claims the benefit of and priority to U.S. Provisional Patent Application 62/854,089, filed on May 29, 2019, which is hereby incorporated by reference in its entirety for all purposes.

### FIELD

Methods and systems disclosed herein relate generally to systems and methods for integrating neural networks, which are of different types and process different types of data. The different types of data may include static data and dynamic data, and the integrated neural networks can include feedforward and recurrent neural networks. Results of the integrated neural networks can be used to configure or modify protocol configurations.

### BACKGROUND

The rate at which data is generated and stored continues to exponentially increase. However, the pure existence of such data is of little value. Rather, the value is seen when the data is properly interpreted and used to derive a result that can inform a subsequent action or decision. Appropriate interpretation can, at times, require collectively interpreting a set of data. This collective data analysis can present challenges as the information within a given data element becomes higher and/or more complex and as the set of data becomes larger and/or more complex (e.g., when the set of data includes more data elements and/or data elements of different data types).

Use of computational techniques can facilitate processing larger and more complex data set. However, many computational techniques are configured to receive and process a single type of data. A technique that can collectively process different types of data has the potential to gain synergistic information, in that the information available in association with the combination of multiple data points (e.g., of different data types) exceeds sum of information associated with each of the multiple data points.

In a particular context, many types of data may be of potential relevance in the clinical-trial context. Conducting a successful clinical trial of an as-of-yet unapproved pharmaceutical treatment can support the identification of the responsive patient population, safety, efficacy, proper dosing regimen, and other characteristics of the pharmaceutical treatment necessary to make that pharmaceutical treatment safely available for patients. However, conducting a successful clinical trial requires defining an appropriate patient group to include in the clinical trial in the first place. Clinical-trial criteria must define inclusion and/or exclusion criteria that include constraints corresponding to each of multiple types of data. If the constraints are too narrow and/or span too many types of data, an investigator may fail to be able to recruit a sufficient number of participants for the trial in a timely manner. Further, the narrow constraints may limit information as to how a given treatment differentially affects different patient groups. Meanwhile, if the constraints are too broad, results of the trial may be sub-optimal in that the results may under-represent an efficacy of a treatment and/or over-represent occurrences of adverse events.

Similarly, the definition of a clinical trial's endpoint(s) will affect efficacy results. If a given type of result is one that depends on one or more treatment-independent factors, there is a risk that results may be misleading and/or biased. Further, if the endpoint(s) is under-inclusive, an efficacy of a treatment may go undetected.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method including: accessing a multi-structure data set corresponding to an entity (e.g., patient having a medical condition, such as a particular disease), the multi-structure data set including: a temporally sequential data subset (e.g., representing results from a set of temporally separated: blood tests, clinical evaluations, radiology images (CT), histological image, ultrasound); and a static data subset (e.g., representing one or more RNA expression levels, one or more gene expression levels, demographic information, diagnosis information, indication of whether each of one or more particular mutations were detected, a pathology image). The temporally sequential data subset has a temporally sequential structure in that the temporally sequential data subset includes multiple data elements corresponding to multiple time points. The static data subset has a static structure (e.g., for which it is inferred that data values remain constant over time, for which only time point is available, or for which there is a significant anchoring time point, such as a pre-training screening). The computer-implemented method also includes executing a recurrent neural network (RNN) to transform the temporally sequential data subset into an RNN output. The computer-implemented method also includes executing a feedforward neural network (FFNN) to transform the static data subset into a FFNN output, where the FFNN was trained without using the RNN and without using training data having the temporally sequential structure. The computer-implemented method also includes determining an integrated output based on the RNN output, where at least one of the RNN output and the integrated output depend on the FFNN output, and where the integrated output corresponds to a prediction of a result (e.g., corresponding to an efficacy magnitude, a binary efficacy indicator, an efficacy time-course metric, a change in disease state, adverse-event incidence, clinical trajectory) of the entity (e.g., an entity receiving a particular type of intervention, particular type of treatment, or particular medication). The computer-implemented method also includes outputting the integrated output. Other embodiments of this aspect include corresponding computer systems, apparatus, and computer programs recorded on one or more computer storage devices, each configured to perform the actions of the methods.

In some instances, the static data subset includes image data and non-image data. The FFNN executed to transform the image data can include a convolutional neural network. The FFNN executed to transform the non-image data can include a multi-layer perceptron neural network.

In some instances, the temporally sequential data subset includes image data, and the recurrent neural network executed to transform the image data includes a LSTM convolutional neural network. The multi-structure data set can include another temporally sequential data subset that includes non-image data. The method can further include executing a LSTM neural network to transform the non-image data into another RNN output. The integrated output can be further based on the other RNN output.

In some instances, the RNN output includes at least one hidden state of an intermediate recurrent layer (e.g., a last layer before a final softmax layer) in the RNN. The multi-structure data set can include another static data subset that includes non-image data. The method can further include executing another FFNN to transform the other static data subset into another FFNN output. The other FFNN output can include a set of intermediate values generated at an intermediate hidden layer (e.g., a last layer before a final softmax layer) in the other FFNN.

In some instances, determining the integrated output includes executing an integration FFNN to transform the FFNN output and the RNN output to the integrated output. Each of the FFNN and the RNN may have been trained without using the integrated FFNN.

In some instances, the method further includes concatenating the FFNN output and a data element of the multiple data elements from the temporally sequential data subset, the data element corresponding to an earliest time point of the multiple time points to produce concatenated data. Executing the RNN to transform the temporally sequential data subset into the RNN output can include using the RNN to process an input that includes the concatenated data and for each other data element of the multiple data elements that correspond to time points of the multiple time points subsequent to the earliest time points, the other data element. The integrated output can include the RNN output.

In some instances, the method further includes generating an input that includes, for each data element of the multiple data elements from the temporally sequential data subset, a concatenation of the data element and the FFNN output. Executing the RNN to transform the temporally sequential data subset into the RNN output can include using the RNN to process the input. The integrated output can include the RNN output.

In some instances, the multi-structure data set includes another temporally sequential data subset that includes other multiple data elements corresponding to the multiple time points and another static data subset of a different data type or data structure than the static data subset. The method can further include executing another FFNN to transform the other static data subset into another FFNN output; executing a first integration neural network to transform the FFNN output and the other FFNN output to a static-data integrated output; and generating an input that includes, for each time point of the multiple time points, a concatenated data element that includes the data element of the multiple data elements that corresponds to the time point and the other data element of the other multiple data elements that corresponds to the time point. Executing the RNN to transform the temporally sequential data subset into the RNN output can include using the RNN to process the input. The RNN output can correspond to a single hidden state of an intermediate recurrent layer in the RNN. The single hidden state can correspond to a single time point of the multiple time points. Determining the integrated output can include processing the static-data integrated output and the RNN output using a second integration neural network.

In some instances, the multi-structure data set includes another temporally sequential data subset that includes other multiple data elements corresponding to the multiple time points another static data subset of a different data type or data structure than the static data subset. The method can further include executing another FFNN to transform the other static data subset into another FFNN output; executing a first integration neural network to transform the FFNN output and the other FFNN output to a static-data integrated output; and generating an input that includes, for each time point of the multiple time points, a concatenated data element that includes the data element of the multiple data elements that corresponds to the time point and the other data element of the other multiple data elements that corresponds to the time point. Executing the RNN to transform the temporally sequential data subset into the RNN output can include using the RNN to process the input. The RNN output can correspond to multiple hidden states in the RNN, each of the multiple time points corresponding to a hidden state of the multiple hidden states. Determining the integrated output can include processing the static-data integration output and the RNN output using a second integration neural network.

In some instances, the multi-structure data set includes another temporally sequential data subset having another temporally sequential structure in that the other temporally sequential data subset includes other multiple data elements corresponding to other multiple time points. The other multiple time points can be different than the multiple time points. The multi-structure data set can further include another static data subset of a different data type or data structure than the static data subset. The method can further include executing another FFNN to transform the other static data subset into another FFNN output; executing a first integration neural network to transform the FFNN output and the other FFNN output to a static-data integrated output; and executing another RNN to transform the other temporally sequential data subset into another RNN output. The RNN may have been trained independently from and executed independently from the other RNN, and the RNN output can include a single hidden state of an intermediate recurrent layer in the RNN. The single hidden state can correspond to a single time point of the multiple time points. The other RNN output include another single hidden state of another intermediate recurrent layer in the other RNN. The other single hidden state can correspond to another single time point of the other multiple time points. The method can also include concatenating the RNN output and the other RNN output. Determining the integrated output can include processing the static-data integrated output and the concatenated outputs using a second integration neural network.

In some instances, the multi-structure data set includes another temporally sequential data subset having another temporally sequential structure in that the other temporally sequential data subset includes other multiple data elements corresponding to other multiple time points, the other multiple time points being different than the multiple time points, and the multi-structure data set also includes another static data subset of a different data type or data structure than the static data subset. The method can further include executing another FFNN to transform the other static data subset into another FFNN output, executing a first integration neural network to transform the FFNN output and the other FFNN output to a static-data integrated output; and executing another RNN to transform the other temporally sequential data subset into another RNN output. The RNN may have been trained independently from and executed independently from the other RNN, the RNN output including multiple hidden states of an intermediate recurrent layer in the RNN. The multiple hidden states can correspond to the multiple time points. The other RNN output can include other multiple hidden states of another intermediate recurrent layer in the other RNN. The other multiple hidden states can correspond to the other multiple time points. The method can also include concatenating the RNN output and the other RNN output. Determining the integrated output can include processing the static-data integrated output and the concatenated outputs using a second integration neural network.

In some instances, the method further includes executing another FFNN to transform the other static data subset into another FFNN output; executing a first integration neural network to transform the FFNN output and the other FFNN output to a static-data integrated output; and concatenating the RNN output and the static-data integrated output. Determining the integrated output can include executing a second integration neural network to transform the concatenated outputs into the integrated output.

In some instances, the method further includes concurrently training the first integration neural network, the second integration neural network and the RNN using an optimization technique. Executing the RNN can include executing the trained RNN. Executing the first integration neural network can include executing the trained first integration neural network, and executing the second integration neural network can include executing the trained second integration neural network.

In some instances, the method further includes accessing domain-specific data that includes a set of training data elements and a set of labels. Each training data element of the set of training data elements can correspond to a label of the set of labels. The method can further include training the FFNN using the domain-specific data.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 shows an interaction system for processing static and dynamic entity data using multi-stage artificial intelligence model according to some embodiments of the invention;

FIGS. 2A-2B illustrate exemplary artificial-intelligence configurations that integrate processing across multiple types of neural networks;

FIG. 3 shows an interaction system for processing static and dynamic entity data using multi-stage artificial intelligence model according to some embodiments of the invention;

FIGS. 4A-4D illustrate exemplary artificial-intelligence configurations that include integration neural networks;

FIG. 5 shows a process for integrating execution of multiple types of neural networks according to some embodiments of the invention;

FIG. 6 shows a process for integrating execution of multiple types of neural networks according to some embodiments of the invention;

FIG. 7 shows exemplary data characterizing the importance of various lab features in predicting responses using an LSTM model; and

FIG. 8 shows exemplary data indicating that low platelet counts are associated with higher survival.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Given that efficacy results of a clinical trial may depend on how clinical trial endpoints are defined, techniques to detect how different endpoints depend on different patient characteristics (e.g., demographic data, medical-test data, medical-record data) can inform strategic design of clinical trials, which can facilitate research and development of treatments. In a related context, many different types of data may be of potential relevance when determining a particular treatment strategy for a given person. The decision may involve determining whether to recommend (or prescribe or use) a particular regimen (e.g., treatment) for a particular person; determining particulars of using a particular treatment for a particular person (e.g., a formulation, dosing regimen and/or duration); and/or selecting a particular treatment from among multiple treatments to recommend (or prescribe or use) for a particular subject. Many types of data that may inform these decisions, including lab results, medical-imaging data, subject-reported symptoms, and previous treatment responsiveness. Further, these types of data points may be collected at multiple time points. Distilling this diverse and dynamic data set to accurately predict the efficacy of various treatments and/or regimens for particular subjects can facilitate intelligent selection and use of treatments in a personalized subject-specific manner.

In some embodiments, techniques are disclosed for integrating processing of different types of input data, to provide personalized predictions of treatments or regimens for subjects and patients. More specifically, different types of artificial-intelligence techniques can be used to process the different types of data to generate intermediate results. Some of the input data can include static data that is substantially unchanged over a given time period, that is only collected once per given time period, and/or for which a statistical value is generated based on an assumption that the corresponding variable(s) is/are static. Some of the input data can include dynamic data that changed or is changing (and/or has the potential to physiologically change) over a given time period, for which multiple data values are collected over a given time period, and/or for which multiple statistical values are generated. Input data of different types may further vary in its dimensionality, value range, accuracy and/or precision. For example, some (dynamic or static) input data may include image data, while other (dynamic or static) input data may include non-image data.

An integrated neural-network system can include a set of neural networks that can be selected to perform initial processing of the different types of input data. The type(s) of data processed by each of the set of neural networks may differ from the type(s) of data processed by each other of the set of neural networks. The type(s) of data to be input to and processed by a given neural network may (but need not) be non-overlapping with the type(s) of data to be input to and processed by each other neural network in the set of neural networks (or by each other neural network in a level of the integrated neural-network system).

In some instances, each neural network of a first subset of the set of neural networks is configured to receive (as input) and process static data, and each neural network of a second subset of the set of neural networks is configured to receive (as input) and process dynamic data. In some instances, the static data is raw static data (e.g., one or more pathology images, genetic sequences, and/or demographic information). In some instances, the static data includes features derived (e.g., via one or more neural networks or other processing) based on raw static data. Each neural network of the first subset may include a feed-forward neural network, and/or each neural network of the second subset may include a recurrent neural network. A recurrent neural network may include (for example) one or more long-short term memory (LSTM) units, one or more gated recurrent units (GRUs), or neither.

In some instances, a neural network (e.g., in the first subset and/or in the second subset) is configured to receive and process image and/or spatial data. The neural network can include a convolutional neural network, such that convolutions of various patches within the image can be generated.

In some instances, each of one, more or all of the set of lower level neural networks (e.g., with each lower-level neural network being computationally closer to input data than one or more upper-level neural networks, which may receive processed versions of input data) may be trained independently and/or with domain-specific data. The training may be based on a training data set that is of a data type that corresponds to the type of data that the neural network is configured to receive and process. In a supervised-learning approach, each data element of the training data set may be associated with a “correct” output, which may correspond to a same type of output that is to be output from the integrated neural-network system and/or a type of output that is specific to the domain (e.g., and not output from the integrated neural-network system).

An output can be used to select a clinical trial protocol configuration, such as a particular treatment to be administered (e.g., a particular pharmaceutical drug, surgery or radiation therapy); a dosage of a pharmaceutical drug; a schedule for administration of a pharmaceutical drug and/or procedure; etc. In some instances, an output can identify a prognosis for a subject and/or a prognosis for a subject if a particular treatment (e.g., having one or more particular protocol configurations) is administered. A user may then determine whether to recommend and/or administer the particular treatment to the subject.

For example, the integrated neural-network system may be configured to output a predicted probability that a particular person will survive 5 years if given a particular treatment. A domain-specific neural network can include a convolutional feed-forward neural network that is configured to receive and process spatial pathology data (e.g., an image of a stained or unstained slice of a tissue block from a biopsy or surgery). This domain-specific convolutional feed-forward neural network may be trained to similarly output 5-year survival probabilities (using training data that associates each pathology data element with a binary indicator as to whether the person survived five years). Alternatively or additionally, the domain-specific neural network may be trained to output an image-processing result, which may include (for example) a segmentation of an image (e.g., to identify individual cells), a spatial characterization of objects detected within an image (e.g., characterizing a shape and/or size), a classification of one or more objects detected within an image (e.g., indicating a cell type) and/or a classification of the image (e.g., indicating a biological grade).

Another domain-specific neural network can include a convolutional recurrent neural network that is configured to receive and process radiology data. The domain-specific recurrent feed-forward neural network may be trained to output 5-year survival probabilities and/or another type of output. For example, the output may include a prediction as to a relative or absolute size of a tumor in five years and/or a current (e.g., absolute) size of a tumor.

Integration between neural networks may occur through one or more separate integration subnet included in the integrated neural-network system and/or may occur as a result of data flow between neural networks in the integrated neural-network system. For example, a data flow may route each output generated for a given iteration from one or more neural networks configured to receive and process static data (“static-data neural network(s)”) to be included in an input data set for the iteration (which can also include dynamic data) to one or more neural networks configured to receive and process dynamic data (“dynamic-data neural network(s)”). The dynamic data may include a set of dynamic data elements that correspond to a set of time points. In some instances, a single dynamic data element of the set of dynamic data elements is concatenated with the output from the static-data neural network(s) (such that the output(s) from the static-data neural network(s) is represented only once in the input data set). In some instances, teach dynamic data element of the set of dynamic data elements is concatenated with the output from the static-data neural network(s) (such that the output(s) from the static-data neural network(s) is represented multiple times in the input data set).

As another example, with respect to each of one, more or all of the dynamic-data neural network(s) in the integrated neural-network system, the input data set need not include any result from any static-data neural network. Rather, a result of each dynamic-data neural network may be independent from any result of any static-data neural network in the integrated neural-network system and/or from any of the static data input into any static-data neural network. The output(s) from each static-data neural network and each dynamic-data neural network can then be aggregated (e.g., concatenated) and input into an integration subnet. The integration subnet may itself be a neural network, such as a feedforward neural network.

In instances in which multiple types of static data are assessed, the integrated neural-network system may include multiple domain-specific neural networks to separately process each type of static data. The integrated neural-network system can also include a static-data integration subnet that is configured to receive output from each of the domain-specific neural networks to facilitate generating an output based on the collection of static data. This output can then be received by a higher level integration subnet, which can also receive dynamic-data elements (e.g., from each of the one or more dynamic-data neural networks) to facilitate generating an output based on the complete data set.

Domain-specific neural networks (e.g., each static-data neural network that is not integrating different data types) are separately trained, and the learned parameters (e.g., weights) are then fixed. In these instances, an output of the integration subnet may be processed by an activation function (e.g., to generate a binary prediction as to whether a given event will occur), whereas lower level neural networks need not include an activation-function layer and/or need not route outputs for immediate processing by an activation function.

In some instances, at least some training is performed across levels of the integrated neural-network system, and/or one or more of the lower level networks may include an activation-function layer (and/or route outputs to an activation function, which can then send its output(s) to the integration layer). For example, a backpropagation technique may be used to concurrently train each integration neural network and each dynamic-data neural network. While low-level domain-specific neural networks may initially be trained independently and/or in domain-specific manners, in some instances, error can subsequently be backpropagated down to these low-level networks for further training. Each integrated neural-network system may use a deep-learning technique to learn parameters across individual neural networks.

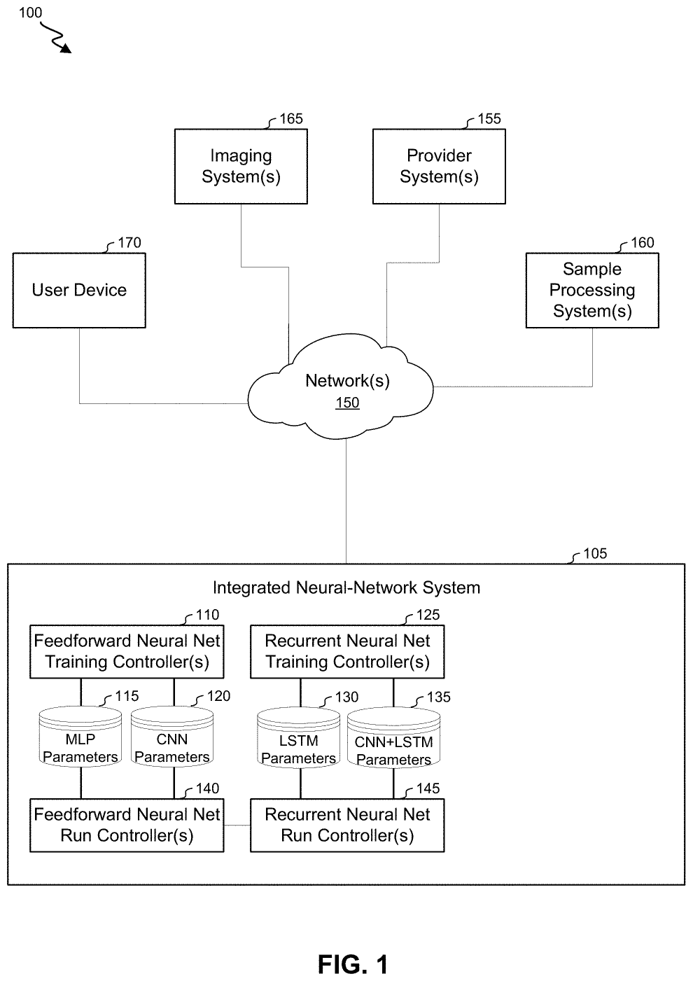

FIG. 1 shows an interaction system 100 for processing static and dynamic entity data using multi-stage artificial intelligence model to predict treatment response, according to some embodiments of the invention. Interaction system 100 can include an integrated neural-network system 105 to train and execute integrated neural networks. More specifically, integrated neural-network system 105 can include a feedforward neural net training controller 110 to train each of one or more feedforward neural networks. In some instances, each feedforward neural network is separately trained (e.g., by a different feedforward neural net training controller 110) apart from the integrated neural-network system 105. In some instances, a softmax layer of a feedforward neural network is removed after training. It will be appreciated that, with respect to any disclosure herein, a softmax layer may be replaced with an activation-function layer that uses a different activation function to predict a label (e.g., a final layer having k nodes to generate a classification output when there are k classes, a final layer using a sigmoid activation function at a single node to generate a binary classification, or a final layer using a linear-activation function at a single node for regression problems). For example, the predicted label may include a binary indicator corresponding to a prediction as to whether a given treatment would be effective at treating a given patient or a numeric indicator corresponding to a probability that the treatment would be effective.

Each feedforward network can include an input layer, one or more intermediate hidden layers and an output layer. From each neuron or perceptron in the input layer and in each output layer, connections may diverge to a set (e.g., all) neurons or perceptrons in a next layer. All connections may extend in a forward direction (e.g., towards the output layer) rather than in a reverse direction.

The feedforward neural networks can include (for example) one or more convolutional feedforward neural networks and/or one or more multi-layer perceptron neural networks. For example, a feedforward neural network can include a four-layer multi-layer perceptron neural network with dropout and potentially normalization (e.g., batch normalization and/or to process static, non-spatial inputs). (Dropout may be selectively performed during training as a form of network regularization but not during an inference stage.) As another example, a feedforward neural network can include a deep convolutional neural network (e.g., InceptionV3, AlexNet, ResNet, U-Net). In some instances, a feedforward neural network can include a top layer for fine tuning that includes a global pooling average layer and/or one or more dense feed forward layers. With respect to each neural network, the training may result in learning a set of parameters, which can be stores in a parameter data store (e.g., a multi-layer perceptron (MLP) parameter data store 110 and/or a convolutional neural network (CNN) parameter data store 115 and/or 120).

Integrated neural-network system 105 can further include a recurrent neural net training controller 125 to train each of one or more recurrent neural networks. In some instances, each recurrent neural network is separately trained (e.g., by a different recurrent neural net training controller 125). In some instances, a softmax layer (or other activation-function layer) of a recurrent neural network is removed after training.

A recurrent neural network can include an, input layer, one or more intermediate hidden layers, and an output layer. Connections can again extend from neurons or perceptrons in an input layer or hidden layer to neurons in a subsequent layer. Unlike feedforward networks, each recurrent neural network can include a structure that facilitates passing information from a processing of a given time step to a next time step. Thus, recurrent neural network includes one or more connections that extend in a reverse direction (e.g., away from the output layer). For example, a recurrent neural network can include one or more LSTM units and/or one or more GRUs that determine a current hidden state and a current memory state for the unit based on current input, a previous hidden state a previous memory state, and a set of gates. A recurrent neural network may include an LSTM network (e.g., 1-layer LSTM network) with softmax (e.g., and an attention mechanism) and/or a long-term recurrent convolutional network. With respect to each neural network, the training may result in learning a set of parameters, which can be stores in a parameter data store (e.g., an LSTM parameter data store 130 and/or a CNN+LSTM parameter data store 135).

Integrated neural-network system 105 can include one or more feedforward neural network run controllers 140 and one or more recurrent neural net run controllers 145 to run corresponding neural networks. Each controller can be configured to receive, access and/or collect input to be processed by the neural network, run the trained neural network (using the learned parameters) and avail the output for subsequent processing. It will be appreciated that the training and execution of each neural network in integrated neural-network system 105 can further depend on one or more hyperparameters that are not learned and instead are statically defined.

In the depicted instance, feedforward neural net run controller(s) 140 avail output from the feedforward neural networks to recurrent neural network run controller(s) 145, such that the feedforward neural-net outputs can be included as part of the input data set(s) processed by the recurrent neural networks. Recurrent neural net run controller(s) 145 may aggregate the output with (for example) dynamic data. Output from a feedforward neural network can include (for example) an output vector from an intermediate hidden layer, such as a last layer before a softmax layer.

In some instances, the data input to the feedforward neural networks is and/or includes static data (e.g., which may include features detected from raw static data), and/or the data input to the recurrent neural networks includes dynamic data. Each iteration may correspond to an assessment of data corresponding to a particular person. The static data and/or dynamic data may be received and/or retrieved from one or more remote devices over one or more networks 150 (e.g., the Internet, a wide-area network, a local-area network and/or a short-range connection). In some instances, a remote device may push data to integrated neural-network system 105. In some instances, integrated neural-network system 105 may pull data from a remote device (e.g., by sending a data request).

At least part of input data to be processed by one or more feedforward neural networks and/or at least part of input data to be processed by one or more recurrent neural networks may include or may be derived from data received from a provider system 155 which may be associated with (for example) a physician, nurse, hospital, pharmacist, etc. associated with a particular person. The received data may include (for example) one or more medical records corresponding to the particular person that are indicative or include demographic data (e.g., age, birthday, ethnicity, occupation, education level, place of current residence and/or place(s) of past residence(s), place(s) of medical treatment); one or more vital signs (e.g., height; weight; body mass index; body surface area; respiratory rate; heart rate; raw ECG recordings; systolic and/or diastolic blood pressures; oxygenation levels; body temperature; oxygen saturation; head circumference), current or past medications or treatments that were prescribed and/or taken (e.g., along with corresponding time periods, any detected adverse effects and/or any reasons for discontinuing) and/or current or past diagnoses; current or past reported or observed symptoms; results of examination (e.g., vital signs and/or functionality scores or assessments); family medical history; exposure to environmental risks (e.g., personal and/or family smoking history, environmental pollution, radiation exposure). It will be appreciated that additional data may be received directly or indirectly from patient-monitoring devices, such as a device that includes one or more sensors to monitor a health-related metric (e.g., a blood glucose monitor, smart watch with ECG electrodes, wearable device that tracks activity, etc.).

At least part of input data to be processed by one or more feedforward neural networks and/or at least part of input data to be processed by one or more recurrent neural networks may include or may be derived from data received from a sample processing system 160. Sample processing system 160 may include a laboratory that has performed a test and/or analysis on a biological sample obtained from the particular person. The sample may include (for example) blood, urine, saliva, fecal matter, a hair, a biopsy and/or an extracted tissue block. The sample processing may include subject the sample to one or more chemicals to determine whether the sample includes a given biological element (e.g., virus, pathogen, cell type). The sample processing may include (for example) a blood analysis, urinalysis and/or a tissue analysis. In some instances, the sample processing includes performing whole genetic sequencing, whole exome sequencing and/or genotyping to identify a genetic sequence and/or detect one or more genetic mutations. As another example, the processing may include sequencing or characterizing one or more properties of a person's microbiome. A result of the processing may include (for example) a binary result (e.g., indicating presence or lack thereof); a numeric result (e.g., representing a concentration or cell count); and/or a categorical result (e.g., identifying one or more cell types).

At least part of input data to be processed by one or more feedforward neural networks and/or at least part of input data to be processed by one or more recurrent neural networks may include or may be derived from data received from an imaging system 165. Imaging system 165 can include a system to collect (for example) a radiology image, CT image, x-ray, PET, ultrasound and/or MM. In some instances, imaging system 165 further analyses the image. The analysis can include detecting and/or characterizing a lesion, tumor, fracture, infection and/or blood clot (e.g., to identify a quantity, location, size and/or shape).

It will be appreciated that, in some instances, sample processing system 160 and imaging system 165 are included in a single system. For example, a tissue sample may be processed and prepared for imaging and an image can then be collected. For example, the processing may include obtaining a tissue slice from a tissue block and staining the slice (e.g., using an H&E stain or IHC stain, such as HER2 or PDL1). An image of the stained slice can then be collected. Further or additionally, it may be determined (based on a manual analysis of the stained sample and/or based on a manual or automated review of the image) whether any stained elements (e.g., having defined visual properties) are observable in the slice.

Data received at or collected at one or more of provider system 155, sample processing system 160 or imaging system 165 may be processed at the respective system or at integrated neural-network system 105 to (for example) to generate input to a neural network. For example, clinical data may be transformed using one-hot encoding, feature embeddings and/or normalization to a standard clinical range, and/or z-scores of housekeeping gene-normalized counts can be calculated based on transcript counts. As other (additional or alternative) examples, processing can include performing featurization, dimensionality reduction, principal component analysis or Correlation Explanation (CorEx). As yet another (additional or alternative) image data may be divided into a set of patches, an incomplete subset of patches can be selected, and each patch in the subset can be represented as a tensor (e.g., having lengths of each of two dimensions corresponding to a width and length of the patch and a length of a third dimension corresponding to a color or wavelength dimensionality). As another (additional or alternative example), processing can include detecting a shape that has image properties corresponding to a tumor and determining one or more size attributes of the shape. Thus, inputs to neural networks may include (for example) featurized data, z-scores of housekeeping gene-normalized counts, tensors and/or size attributes.

Interaction system 100 can further include a user device 170, which can be associated with a user that is requesting and/or coordinating performance of one or more iterations (e.g., with each iteration corresponding to one run of the model and/or one production of the model's output(s)) of the integrated neural-network system. The user may correspond to an investigator or an investigator's team for a clinical trial. Each iteration may be associated with a particular person, who may be different than the user. A request for the iteration may include and/or be accompanied with information about the particular person (e.g., an identifier of the person, an identifier of one or more other systems from which to collect data and/or information or data that corresponds to the person). In some instances, a communication from user device 170 includes an identifier of each of a set of particular people, in correspondence with a request to perform an iteration for each person represented in the set.

Upon receiving the request, integrated neural-network system 105 can send requests (e.g., to one or more corresponding imaging system 165, provider system 155 and/or sample processing system 160) for pertinent data and execute the integrated neural network. A result for each identified person may include or may be based on one or more outputs from one or more recurrent networks (and/or one or more feedforward neural networks). For example, a result can include or may be based on a final hidden state of each of one or more intermediate recurrent layers in a recurrent neural network (e.g., from the last layer before the softmax). In some instances, such outputs may be further processed using (for example) a softmax function. The result may identify (for example) a predicted efficacy of a given treatment (e.g., as a binary indication as to whether it would be effective, a probability of effectiveness, a predicted magnitude of efficacy and/or a predicted time course of efficacy) and/or a prediction as to whether the given treatment would result in one or more adverse events (e.g., as a binary indication, probability or predicted magnitude). The result(s) may be transmitted to and/or availed to user device 170.

In some instances, some or all of the communications between integrated neural-network system 105 and user device 170 occurs via a website. It will be appreciated that integrated neural-network system 105 may gate access to results, data and/or processing resources based on an authorization analysis.

While not explicitly shown, it will be appreciated that interaction system 100 may further include a developer device associated with a developer. Communications from a developer device may indicate (for example) what types of feedforward and/or recurrent neural networks are to be used, a number of neural networks to be used, configurations of each neural network, one or more hyperparameters for each neural networks, how output(s) from one or more feedforward neural networks are to be integrated with dynamic-data input to form an input data set for a recurrent neural network, what type of inputs are to be received and used for each neural network, how data requests are to be formatted and/or which training data is to be used (e.g., and how to gain access to the training data).

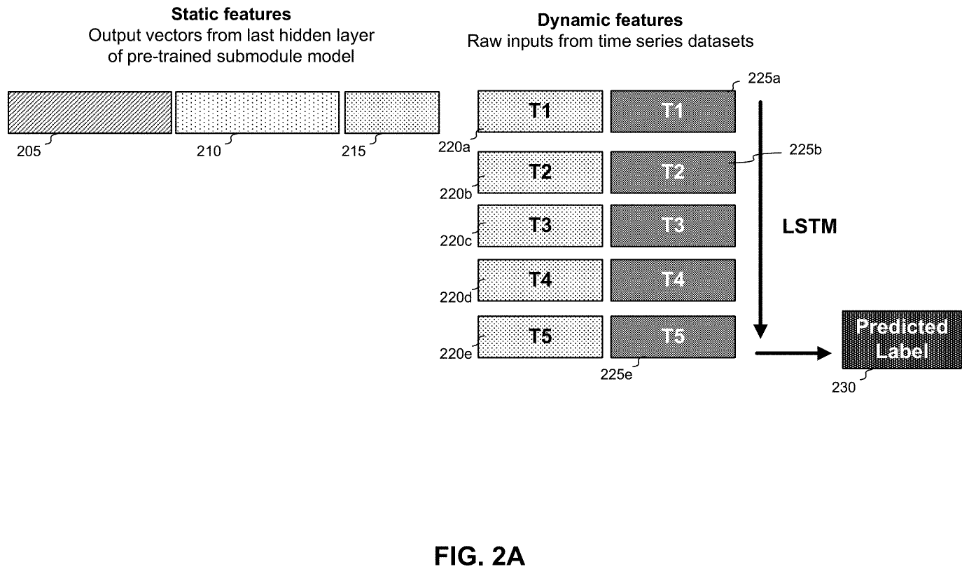

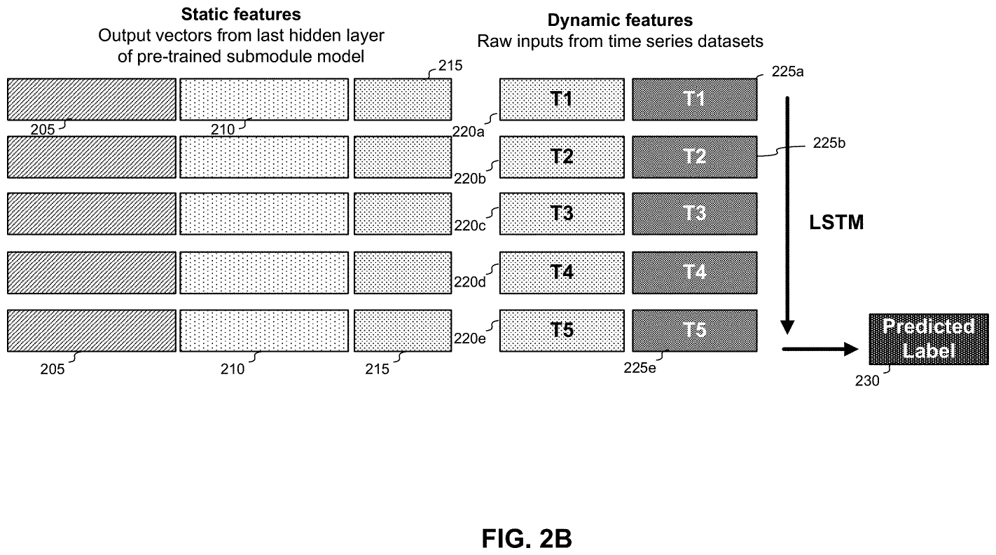

FIGS. 2A-2B illustrate exemplary artificial-intelligence configurations that integrate processing across multiple types of treatment prediction neural networks. The depicted networks illustrate particular techniques by which dynamic and static data can be integrated into a single input data set that can be fed to a neural network. The neural network can then generate an output that (for example) predicts a prognosis of a particular subject, an extent to which a particular treatment would effectively treat a medical condition of the particular subject; an extent to which a particular treatment would result in one or more adverse events for a particular subject; and/or a probability that a particular subject will survive (e.g., in general or without progression of a medical condition) for a predefined period of time if a particular treatment is provided to the subject. Using a single network can result in less computationally intensive and/or time intensive training and/or processing as compared to using other techniques that rely upon separately processing the different input data sets. Further, a single neural network can facilitate interpreting learned parameters to understand which types of data were most influential in generating outputs (e.g., as compared to processing that relies on the use of multiple types of data processing and/or multiple types of models).

In FIG. 2A, each of blocks 205, 210 and 215 represent an output data set (inclusive of one or more output values) from processing a corresponding input data set using a respective trained feedforward neural network. For example, block 205 may include outputs from a first multi-layer perceptron feedforward neural network generated based on static RNA sequence input data; block 210 may include outputs from a second multi-layer perceptron feedforward neural network generated based on static clinical input data (e.g., including a birthdate, residence location, and/or occupation); and block 215 may include outputs from a convolutional neural network (e.g., deep convolutional neural network) generated based on static pathology input data (e.g., including an image of a stained sample slice).

A recurrent neural net run controller can be configured to aggregate these outputs with dynamic-data input to generate an input for one or more recurrent neural networks. In the depicted instance of FIG. 2A, the dynamic-data input includes a first set of dynamic data 220a-220e that corresponds to five time points and a second set of dynamic data 225a-225e that corresponds to the same five time points. For example, first set of dynamic data 220a-220e may include clinical data (e.g., representing symptom reports, vital signs, reaction times, etc.) and/or results from radiology evaluations (e.g., identifying a size of a tumor, a size of a lesion, a number of tumors, a number of lesions, etc.).

Continuing with the example of FIG. 2A, the controller aggregates (e.g. concatenates) the data from each of data blocks 205, 210 and 215 (representing outputs from three feedforward networks) with dynamic-data input for a single (e.g., first) time point from each of first set of dynamic data 220a and second set of dynamic data 225a. For the remaining four time points, only the dynamic data (e.g., 220b and 225b) are aggregated. Thus, an input data set for the recurrent network (e.g., LSTM model) includes data elements that vary in size across time points.

The recurrent neural network may generate an output 230, that includes one or more predicted labels. A label may correspond to a classification indicating (for example) whether a condition of a person to whom the input corresponds would respond to a given treatment, would respond in a target time period, would respond within a target degree of magnitude range and/or would experience any substantial (e.g., pre-identified) adverse event. A label may alternatively or additionally correspond to an output along a continuum, such as a predicted survival time, magnitude of response (e.g., shrinkage of tumor size), functional performance measure, etc.

Alternatively, in FIG. 2B, the data from each of data blocks 205, 210 and 215 (representing outputs from three feedforward networks) is aggregated with dynamic-data input at each time point. For example, not only are data blocks 205-215 aggregated with dynamic-data inputs for a first time point of each of first set of dynamic data 220a and second set of dynamic data 225a, but they are also aggregated with dynamic-data inputs corresponding to a second time point 220b and 220c, etc. Notably, the data in each of data blocks 205-215 remains the same even though it is aggregated with different dynamic data. In this instance, an input data set for the concurrent network can include data elements (the aggregated data) that is of a same size across time points.

It will be appreciated that, while FIGS. 2A-2B only depict a single recurrent neural network, multiple recurrent networks may instead be used. For example, outputs from the feedforward neural network may be aggregated (e.g., in accordance with a technique as illustrated in FIG. 2A or FIG. 2B) with one or more first dynamic data sets (e.g., including non-image data) to generate a first input set to be processed by a first recurrent neural network, and the outputs from the feedforward neural network may be aggregated with one or more second dynamic data sets (e.g., including image data) to generate a second input set to be processed by a second recurrent neural network (e.g., a convolutional recurrent neural network).

With respect to each of FIGS. 2A and 2B, the depicted configuration can be trained by performing domain-specific training of each of the feedforward neural networks. The weights may then be fixed. In some instances, errors can be backpropagated through the recurrent model to train the recurrent network(s). In some instances, weights of the feedforward neural network(s) are not fixed after domain-specific training, and the backpropagation can extend through the feedforward network(s).

Feeding output(s) from the feedforward network(s) to the recurrent network(s) can facilitate processing distinct data types (e.g., static and dynamic) while avoiding additional higher level networks or processing elements that receive input from the feedforward and recurrent networks. Avoiding these additional networks or processing elements can speed learning, avoid overfitting and facilitate interpretation of learned parameters. Thus, the networks of FIGS. 2A-2B may be used to generate accurate predictions pertaining to prognosis of particular subjects (e.g., while receiving a particular treatment). The accurate predictions can facilitate selecting personalized treatment for particular subjects.

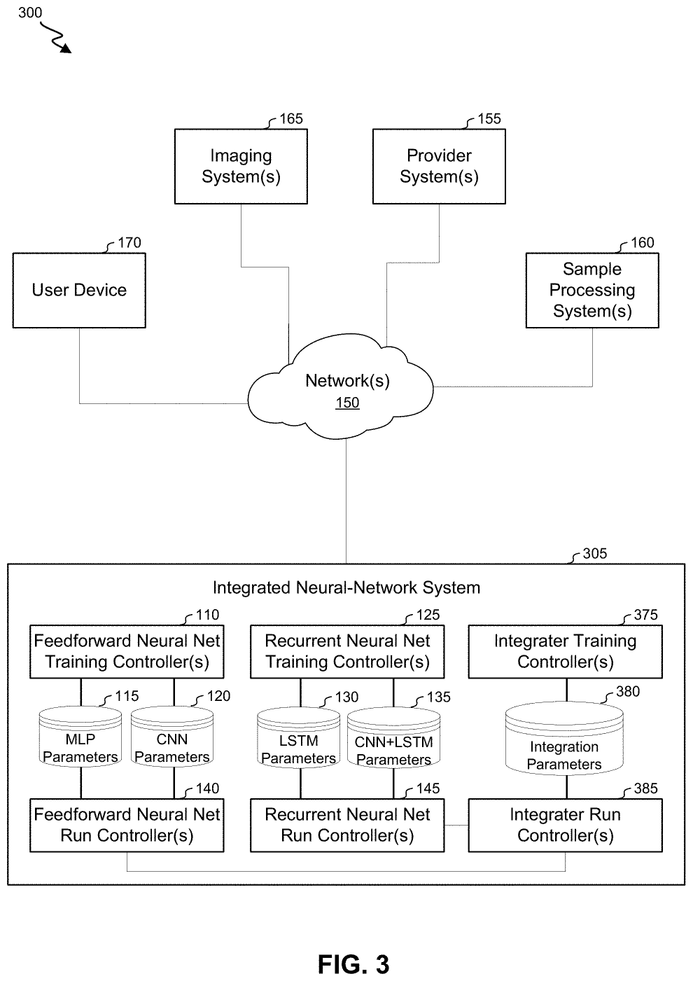

FIG. 3 shows an interaction system 300 for processing static and dynamic entity data using multi-stage artificial intelligence model predict treatment response, according to some embodiments of the invention.

Interaction system 300 depicted in FIG. 3 includes many of the same components and connections as include in interaction system 100 depicted in FIG. 1. An integrated neural-network system 305 in interaction system 300 may include controllers for one or more integration networks in addition to controllers for feedforward and recurrent networks. Specifically, integrated neural-network system 305 includes an integrater training controller 375 that trains each of one or more integration subnets so as to learn one or more integration-layer parameters, which are stored in an integration parameters data store 380.

The integration subnet can include a feedforward network, which can include one or more multi-layer perceptron networks (e.g., with batch normalization and dropout). A multi-layer perceptron network can include (for example) five layers, fewer or more. The integration subnet can include one or more dense layers and/or one or more embedding layers.

In some instances, one or more first-level domain-specific (e.g., feedforward) neural networks are pretrained independently from other models. The integration subnet need not be pretrained. Rather, training may occur while all neural networks are integrated (e.g., using or not using backpropagation and/or using or not using forward propagation). Another type of optimization training method can also or alternatively be used, such as a genetic algorithm, evolution strategy, MCMC, grid search or heuristic method.

An integrater run controller 385 can run a trained integration subnet (using the learned parameters from integration parameter data store or initial parameter values if none have yet been learned). In some instances, a first integration subnet receives and integrates outputs from each of multiple domain-specific (e.g., feedforward) neural networks, and a second integration subnet receives and integrates outputs from the first integration subnet and each of one or more recurrent neural networks. Notably, in the depicted instance of FIG. 3, output from the lower level feedforward network(s) need not be availed to or sent to recurrent neural net run controller 145. Rather, the integration of the output occurs at the integration subnet.

An output of the integration subnet(s) may include (for example) a final hidden state of an intermediate layer (e.g., the last layer before the softmax layer or the final hidden layer) or an output of the softmax layer. A result generated by and/or availed by integrated neural-network system 305 may include the output and/or a processed version thereof. The result may identify (for example) a predicted efficacy of a given treatment (e.g., as a binary indication as to whether it would be effective, a probability of effectiveness, a predicted magnitude of efficacy and/or a predicted time course of efficacy) and/or a prediction as to whether the given treatment would result in one or more adverse events (e.g., as a binary indication, probability or predicted magnitude).

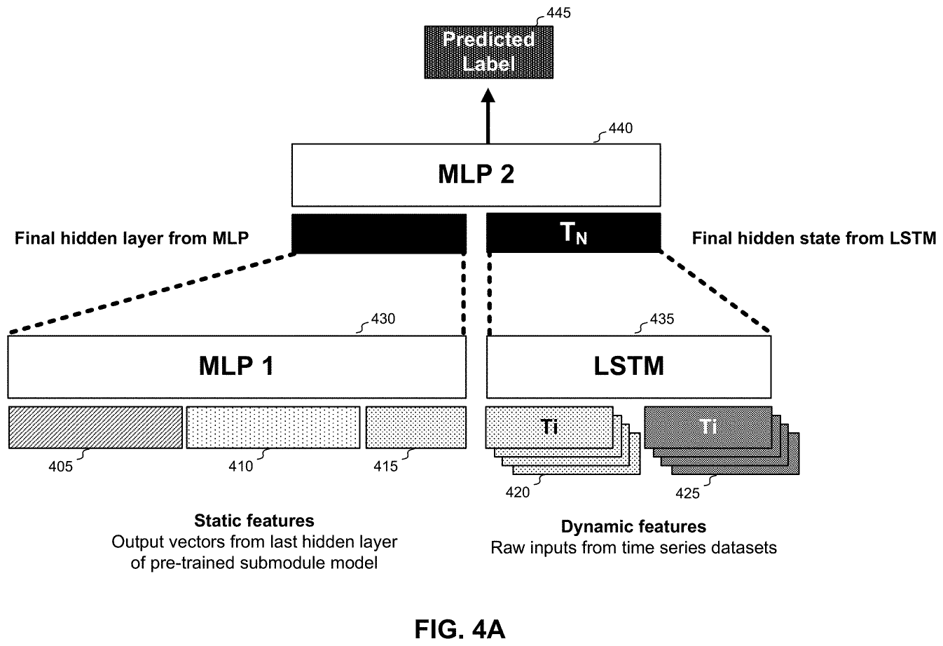

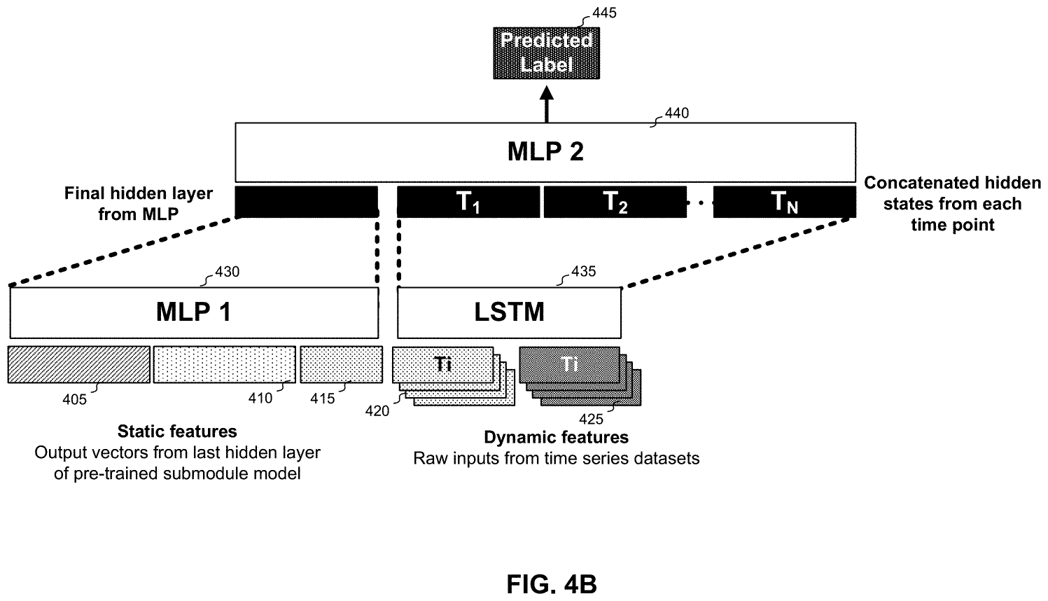

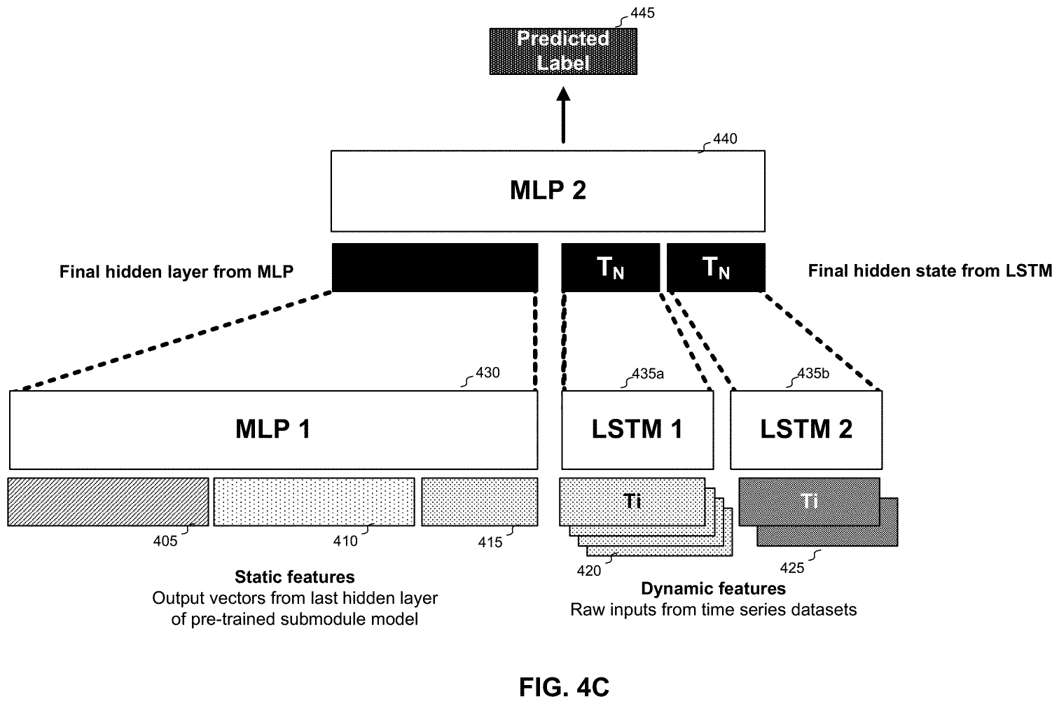

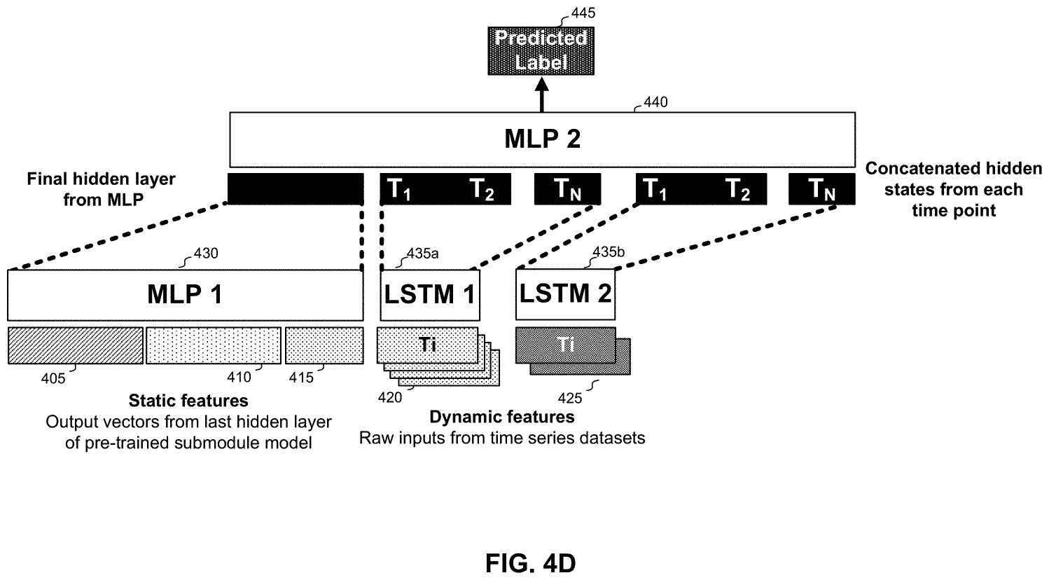

FIGS. 4A-4D illustrate exemplary artificial-intelligence configurations that include integration of treatment prediction neural networks. In each instance, the integrated artificial-intelligence system includes: one or more low-level feedforward neural networks; one or more low-level recurrent neural networks; and one or more high-level feedforward neural networks. In each depicted instance, the artificial-intelligence system uses multiple neural networks, which include one or more models to process dynamic data to generate dynamic-data interim outputs, one or more models to process static features to generate static-data interim outputs, and one or more models to process the dynamic-data interim outputs and static-data interim outputs. One complication with integrating static and dynamic data into a single input data set to be processed by a single model is that such data integration may risk overweighting one input data type over another input data type and/or may risk that the single model does not learn and/or detect data predictors due to a large number of model parameters and/or due to large input data sizes. Using multiple different models to initially process different types of input data may result in a smaller collective set of parameters that are learned, which may improve accuracy of model predictions and/or allow for the models to be trained with a smaller training data set.

With respect to the representation depicted in FIG. 4A, a first set of domain-specific modules can each include a neural network (e.g., a feedforward neural network) that is trained and configured to receive and process static data and to output domain-specific metrics and/or features. The outputs of each module are represented by data blocks 405 (representing RNA sequence data), 410 (e.g., representing pathology stained-sample data) and 415 (e.g., representing demographics and biomarkers) and can correspond to (for example) the last hidden layer in a neural network of the module. Each of one, more or all of the first set of domain-specific modules can include a feedforward neural network. These outputs can be concatenated and fed to a low-level feedforward neural network 430, which can include a multi-layer perceptron neural network.

A recurrent neural network 435 (e.g., an LSTM network) can receive a first set of dynamic data 420 (e.g., representing clinical data) and a second set of dynamic data 425 (e.g., representing radiology data). First set of dynamic data 420 may have a same number of data elements as second set of dynamic data 425. While initially obtained data elements corresponding to the first set may differ in quantity and/or timing correspondence as compared to that of initially obtained data elements corresponding to the second set, interpolation, extrapolation, downsampling and/or imputation may be performed to result in two data sets of a same length. In some instances, each of the sets of dynamic data is generated based on raw inputs from a corresponding time-series data set. For example, first set of dynamic data 420 may identify a set of heartrates as measured at different times, and second set of dynamic data 425 may identify a blood pressure as measured at different times. The depicted configuration may provide operational simplicity in that different dynamic data sets can be collectively processed. However, this collective processing may require the different dynamic data sets to be of a same data size (e.g., corresponding to same time points).

It will be appreciated that, while certain descriptions and figures may refer to a “first” data set (e.g., first set of dynamic data 420) and a “second” data set (e.g., second set of dynamic data 425), the “first” and “second” adjectives are used for distinction convenience. Either of the first data set and the second data set may include multiple data subsets (e.g., collected from different sources, collected at different times and/or representing different types of variables). In some instances, the first data set and second data set may each be subsets of a single data set (e.g., such that a data source and/or collection time is the same between the sets). In some instances, more than two data sets (e.g., more than two dynamic data sets) are collected and processed.

In some instances, each element of each of the sets of dynamic data is generated based on a feedforward neural network configured to detect one or more features. For example, a raw-data initial set may include multiple MRI scans collected at different times. The scan(s) from each time can be fed through the feedforward neural network to detect and characterize (for example) any lesions and/or atrophy. In some instances, for each time point, an image may be processed by a feedforward convolutional neural network, and outputs of the final hidden layer of the convolutional neural network can then be passed forward as an input (that corresponds to the time point) to a recurrent neural network (e.g., LSTM network). First set of dynamic data 420 may then include lesion and atrophy metrics for each of the different times.

Outputs of each of low-level feedforward neural network 430 and low-level recurrent neural network 435 can be fed to a high-level feedforward neural network 440. In some instances, outputs are concatenated together to form a single vector. In some instances, the output(s) from low-level feedforward neural network 430 is of a same size as a size of the output(s) from low-level recurrent neural network 435. The outputs from low-level feedforward neural network 430 can include values from a final hidden layer in each of the networks. Outputs from low-level recurrent neural network 435 can include a final hidden state.

High-level feedforward neural network 440 can include another multi-layer perceptron network. High-level feedforward neural network 440 can output one or more predicted labels 445 (or data from which a predicted label can be derived) from a softmax layer (or other activation-function layer) of the network. Each predicted label can include an estimated current or future characteristic (e.g., responsiveness, adverse-event experience, etc.) of a person associated with the input data 405-425 (e.g., after receiving a particular treatment)

Backpropagation may be used to collectively train two or more networks in the depicted system. For example, backpropagation may reach each of high-level feedforward neural network 440, low-level feedforward neural network 430 and low-level recurrent neural network 435. In some instances, backpropagation can further extend through each network in each domain-specific module, such that the parameters of the domain-specific modules may be updated due to the training of the integrated network. (Alternatively, for example, each network in each domain-specific modules can be pre-trained, and the learned parameters can then be fixed.)

The configuration represented in FIG. 4A allows for data to be represented and integrated in its native state (e.g., static vs. dynamic). Further, static and dynamic components can be concurrently trained. Also, in instances in which outputs from low-level feedforward neural network 430 that are fed to high-level feedforward neural network 440 are of a same size as are outputs from low-level recurrent neural network 435 that are fed to high-level feedforward neural network 440, bias towards either the static or the dynamic component may be reduced.

The configuration shown in FIG. 4B includes many similarities to that of FIG. 4A. However, in this instance, low-level recurrent neural network 435 outputs data for each time step represented in first set of dynamic data 420 (which correspond to same time steps as represented in second set of dynamic data 425). Thus, data that is input to high-level feedforward neural network 440 can include (for example) output from a final hidden layer of low-level feedforward neural network 430 and hidden-state outputs from each time point from low-level feedforward neural network 435.

In this model configuration, information about the evolution of the time series over multiple (e.g., all) of the time points can be propagated, rather than just the information captured in the final hidden state which primarily relates to the prediction of the subsequent time point. Propagating time-point-specific data can allow higher level networks to detect time-series patterns (e.g., periodic trends, occurrence of abnormal values, etc.), which may be more informative than the future value of the time series for predicting the correct label. However, this configuration may fix (e.g., hard code) a number of time points assessed by the recurrent neural network, which can make the model less flexible for inference.

Processing first set of dynamic data 420 and second set of dynamic data 425 concurrently with a same low-level recurrent neural network may result in requiring the data sets to be a same length. Another approach is to separately process the data sets using different neural networks (e.g., a first low-level recurrent neural network 435a and a second low-level recurrent neural network 435b), as shown in FIG. 4C.

In some instances, to reduce biasing an output of high-level feedforward neural network 440 towards dynamic data as may occur in an implementation of the architecture illustrated in FIG. 4B, output from each low-level recurrent neural network 435 is reduced in size (relative to a size of an output of low-level feedforward neural network 430) by a factor equal to a number of the low-level recurrent neural networks. Thus, in the depicted instance, given that there are two low-level recurrent neural networks, the output of each is configured to be half the length of the length of the output of low-level feedforward neural network 430.

This configuration may have advantages including offering an efficient build and implementation process and differentially representing static and dynamic data so as to allow for tailored selection of neural-network types. Other advantages include enabling multiple networks (spanning static and dynamic networks) to be concurrently trained. Bias towards static and/or dynamic data is constrained as a result of proportioned input to high-level feedforward neural network. The configuration can support processing of dynamic data having different data-collection times, and the configuration is extensible for additional dynamic data sets.

FIG. 4D shows yet another configuration that includes multiple low-level recurrent neural networks, but outputs from each correspond to multiple time points (e.g., each time point that was represented in a corresponding input data set). In various instances, a vector length of the output (e.g., the number of elements or feature values passed as output from the low-level recurrent neural networks) from each network may (but need not) be scaled based on a number of low-level recurrent neural networks being used and/or a number of time points in a data set. For example, if a first dynamic data set includes data values for each of 100 time points, while a second dynamic data set includes data values for each of 50 time points, potentially a first neural network processing the first dynamic data set may be configured to generate time-point-specific outputs that are half the length of time-point-specific outputs generated by a second neural network processing the second dynamic data set.

It will be appreciated that each of FIGS. 4A-4D includes multiple integration subnets. Specifically, each of low-level feedforward neural network 430 and high-level feedforward neural network 440 are integrating results from multiple other neural networks. Many neural networks are configured to learn how particular combinations of input values relate to output values. For example, a prediction accuracy of a model that independently assesses the value of each pixel in an image may be far below the prediction accuracy of a model that collectively assess pixel values. However, learning these interaction terms can require an exponentially larger amount of training data, training time and computational resources as the size of an input data set increases. Further, while such data relationships may occur across some types of input data (e.g., across pixels in an image), they need not in other types of input data (e.g., a pixel value of a CT scan and a blood-pressure result may fail to exhibit data synergy). Use of separate models may facilitate capturing data interactions across portions of input data in which the data interactions are likely to be present and/or strongest while preserving computational resources and processing time. Thus, a model having a configuration as depicted in any of FIGS. 4A-4D that relies on multi-level processing may generate results of improved accuracy by capturing pertinent data interaction terms and by producing accurate results based on a training data set of an attainable size. These results may include prognosis of particular subjects (e.g., if a particular treatment is provided). Accurate results can thus promote selecting effective and safe treatments in an individualized manner.

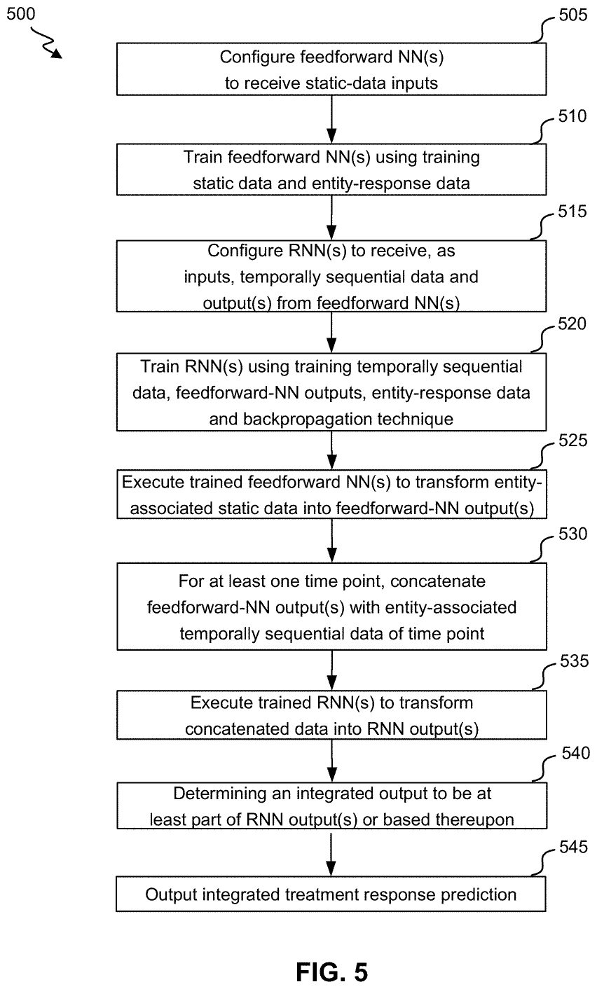

FIG. 5 shows a process 500 for integrating execution of multiple types of treatment prediction neural networks according to some embodiments of the invention. Process 500 can illustrate how neural-network models, such as those having an architecture depicted in FIG. 2A or 2B, can be trained and used.

Process 500 begins at block 505, at which one or more feedforward neural networks are configured to receive static-data inputs. For example, one or more hyperparameters and/or structures may be defined for each of the one or more feedforward neural networks; data feeds may be defined or configured to automatically route particular types of static data to a controller of the feedforward neural network(s) and/or data pulls can be at least partly defined (e.g., such that a data source is identified, data types that are to be requested are identified, etc.).

At block 510, the one or more feedforward neural networks are trained using training static data and training entity-response data (e.g., indicating efficacy, adverse effect occurrence, response timing, etc.). The training data may correspond (for example) to a particular treatment or type of treatment. One or more parameters (e.g., weights) may be learned through the training and subsequently fixed.

At block 515, one or more recurrent neural networks are configured. The configuration can include defining one or more hyperparameters and/or network structures, data feeds and/or data pulls. The configuration can be performed such that each of the one or more recurrent neural networks is configured to receive, as input, dynamic data (e.g., temporally sequential data) and also outputs from each of the one or more feedforward neural networks. The outputs from the feedforward neural networks can include (for example) outputs from a last hidden layer in the feedforward neural network(s).

At block 520, the one or more recurrent neural networks are trained using temporally sequential data, outputs from the one or more feedforward neural networks, entity-response data and a backpropagation technique. The temporally sequential data can include dynamic data. The temporally sequential data (and/or dynamic data) can include an ordered set of data corresponding to (e.g., discrete) time points or (e.g., discrete) time periods. The entity-response data may correspond to empirical and/or observed data associated with one or more entities. The entity-response data may include (for example) binary, numeric or categorical data. The entity-response data may correspond to a prediction as to (for example) whether an entity (e.g., person) will respond to a treatment, a time-course factor for responding to a treatment, a magnitude factor for responding to a treatment, a magnitude factor of any adverse events experienced, and/or time-course factor for responding to a treatment. The backpropagation technique can be used to adjust one or more parameters of the recurrent neural network(s) based on how a predicted response (e.g., generated based on current parameters) compares to an observed response.

At block 525, the trained feedforward neural network(s) are executed to transform entity-associated static data into feedforward-neural-network output(s). The entity-associated static data may correspond to an entity for which a treatment has yet to be administered and/or an observation period has yet to elapse. The entity-associated static data may have been received from (for example) one or more provider systems, sample processing systems, imaging systems and/or user devices. Each of the feedforward-neural-network output(s) may include a vector of values. In some instances, different types of entity-associated static data are processed using different (and/or different types of and/or differently configured) feedforward neural networks and generate different outputs (e.g., which may, but need not, be of different sizes).

At block 530, with respect to at least one time point, the feedforward neural network output(s) are concatenated with entity-associated temporally sequential data associated with that time point. The feedforward neural network output may include output from a last hidden layer of the feedforward neural network. In some instances, the entity-associated temporally sequential data can include one or more pieces of dynamic data associated with a single time point. The concatenated data can include a vector of data. In some instances, the entity-associated temporally sequential data can include one or more pieces of dynamic data associated with multiple time points. The concatenated data can include multiple vectors of data.

At block 535, the trained recurrent neural network is executed to transform the concatenated data into one or more recurrent neural network outputs. More specifically, in some instances, an input data set can be defined to include (for example) only the concatenated data (e.g., in instances in which the feedforward neural network outputs were concatenated with temporally sequential data from each time point represented in the temporally sequential data. In some instances, an input data set can be defined to include (for example) the concatenated data and other (non-concatenated) temporally sequential data (e.g., in instances in which the feedforward neural network outputs were concatenated with temporally sequential data from an incomplete subset of time points represented in the temporally sequential data.

At block 540, an integrated output is determined to be at least part of the recurrent neural network output and/or to be based on at least part of the recurrent neural network outputs. For example, the recurrent neural network output can include a predicted classification or predicted value (e.g., numeric value). As another example, the recurrent neural output can include a number, and the integrated output can include a categorical label prediction determined based on one or more numeric thresholds.

At block 545, the integrated output is output. For example, the integrated output can be presented at or transmitted to a user device.

It will be appreciated that various modifications to process 500 are contemplated. For example, blocks 510 and 520 may be omitted from process 500. Process 500 may nonetheless use trained neural networks, but the networks may have been previously trained (e.g., using a different computing system).

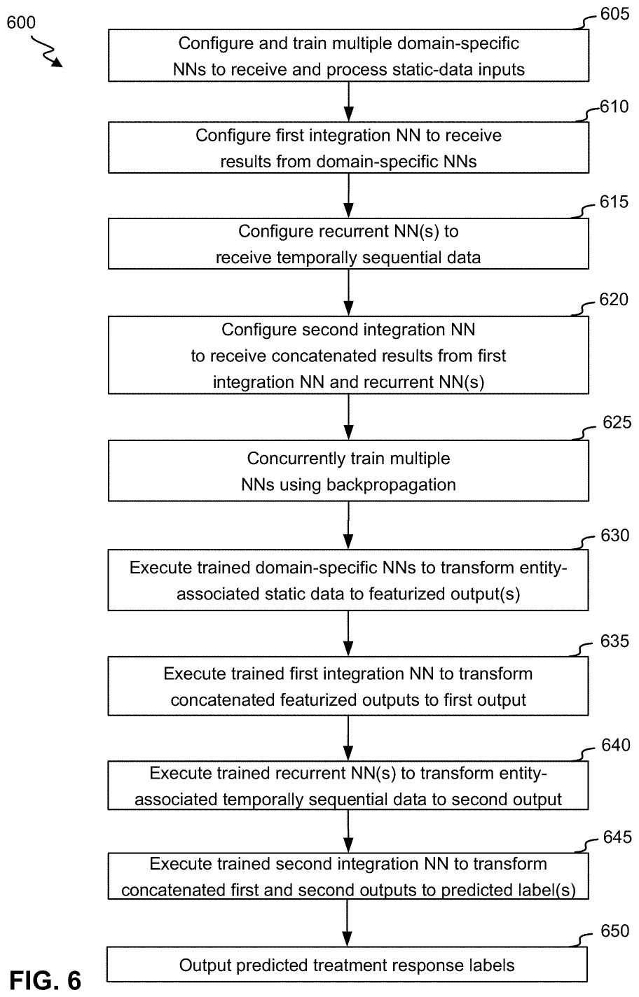

FIG. 6 shows a process 600 for integrating execution of multiple types of treatment prediction neural networks according to some embodiments of the invention. Process 600 can illustrate how neural-network models, such as those having an architecture depicted in any of FIGS. 4A-4D, can be trained and used.

Process 600 at block 605, at which multiple domain-specific neural networks are configured and trained to receive and process static-data inputs. The configuration can include setting hyperparameters and identifying a structure for each neural network. The domain-specific neural networks can include one or more non-convolutional feedforward networks and/or one or more convolutional feedforward networks. In some instances, each domain-specific neural network is trained separately from each other domain-specific neural network. Training data may include training input data and training output data (e.g., that identifies particular features). For example, training data may include a set of images and a set of features (e.g., tumors, blood vessels, lesions) detected based on human annotation and/or human review of past automated selection.

Static inputs may include genetic data (e.g., identifying one or more sequences), pathology image data), demographic data and/or biomarker data. A first (e.g., non-convolutional feedforward) neural network can be configured to process the genetic data to detect features such as one or more mutations, one or more genes, and/or one or more proteins. A second (e.g., convolutional feedforward) neural network can be configured to process the pathology image data to detect features such as a presence, size and/or location of each of one or more tumors and/or identifying one or more cell types. A third (e.g., non-convolutional feedforward) neural network can be configured to process the demographic data and/or biomarker data to detect features such as a baseline disease propensity of a person. In some instances, each of the multiple domain-specific neural networks is configured to generate a result (e.g., a vector of values) that is the same size as the result from each other of the multiple domain-specific neural networks.

At block 610, a first integration neural network is configured to receive results from the domain-specific neural networks. The results from the domain-specific neural networks can be aggregated and/or concatenated (e.g., to form a vector). In some instances, a coordinating code can be used to aggregate, reconfigure (e.g., concatenate) and/or pre-process data to be provided as an input to one or more neural networks. The first integration neural network may include a feedforward neural network and/or a multi-layer perceptron network.

At block 615, one or more recurrent neural networks are be configured to receive temporally sequential data. In some instances, each of multiple recurrent neural networks are configured to receive different temporally sequential data sets (e.g., associated with different time points and/or data sampling). The one or more recurrent neural networks may include (for example) a network including one or more LSTM units and/or one or more GRU units. In some instances, the one or more recurrent neural networks are configured to receive temporally sequential data includes imaging data (e.g., MRI data, CT data, angiography data and/or x-ray data), clinical-evaluation data and/or blood-test data.

In some instances, a single recurrent neural network is configured to receive one or more temporally sequential data sets (e.g., associated with similar or same time points and/or data sampling). In some instances, a coordinating code can be used to transform each of one or more temporally sequential data sets to include data elements corresponding to standardized time points and/or time points of one or more other temporally sequential data sets (e.g., using interpolation, extrapolation and/or imputation).

At block 620, a second integration neural network is configured to receive concatenated results from the first integration neural network and from the one or more recurrent neural networks. The second integration neural network can include a feedforward neural network and/or a multi-layer perceptron network.

In some instances, the result from the first integration neural network is a same size (e.g., a same length and/or of same dimensions) as the result(s) from the one or more recurrent neural network. For example, if a result from the first integration neural is 1×250, and if the one or more recurrent neural networks is two recurrent neural networks, the result from each of the two recurrent neural networks can have a size of 1×125 such that the combined input size corresponding to the temporally sequential data is the same size as the input corresponding to the static data. In some instances, the result from the first integration is a different size than the result(s) from the one or more recurrent neural networks. For example, with respect to the previous example, the result from each of the two recurrent neural networks can have a size of 1×250 or 1×500, or the sizes of the results from the two recurrent neural networks may be different.

At block 625, multiple neural networks are concurrently trained using backpropagation. In some instances, the first and second integration neural networks and the recurrent neural network(s) are concurrently and collectively trained using backpropagation. In some instances, the multiple domain-specific neural networks are also trained with the other networks using backpropagation. In some instances, the multiple domain-specific neural networks are separately trained (e.g., prior to the backpropagation training). The separate training may include independently training each of the domain-specific neural networks.

At block 630, the trained domain-specific neural networks are executed to transform entity-associated static data to featurized outputs. The entity-associated static data may include multiple types of static data, and each type of entity-associated static data may be independently processed using a corresponding domain-specific neural network.

At block 635, the trained first integration neural network is executed to transform the featurized outputs to a first output. Prior to the execution, the featurized outputs from each of the multiple domain-specific neural networks can be combined and/or concatenated (e.g., to form an input vector). The first output may include a vector. The vector may correspond to a hidden layer (e.g., a final hidden layer) of the first integration neural network.

At block 640, the trained recurrent neural network(s) are executed to transform entity-specific temporally sequential data to a second output. In some instances, the entity-specific temporally sequential data includes multiple types of data. The multiple types may be aggregated (e.g., concatenated) at each time point. The multiple types may be separately processed by different recurrent neural networks.

The second output can include a vector. The vector can correspond to a hidden state (e.g., final hidden state) from the recurrent neural network.

At block 645, the trained second integration neural network is executed to transform the first and second outputs to one or more predicted labels. Prior to the execution, a coordinating code can aggregate and/or concatenate the first and second outputs (e.g., to form an input vector). Execution of the second integration neural network can generate an output that corresponds to one or more predicted labels.

At block 650, the one or more predicted labels can be output. For example, the one or more predicted labels can be presented at or transmitted to a user device.

It will be appreciated that various modifications to process 600 are contemplated. For example, block 625 may be omitted from process 600. Process 600 may nonetheless use trained neural networks, but the networks may have been previously trained (e.g., using a different computing system).

### Example

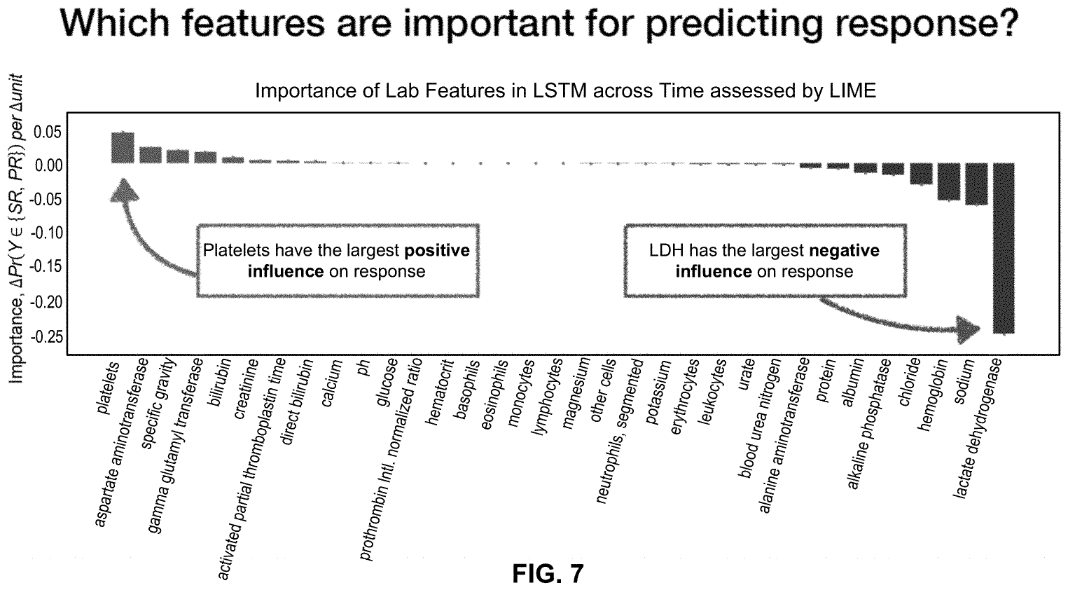

To investigate the performance of using neural networks to predict response characteristics, an LSTM model (which may be used in any of the models depicted in FIGS. 4A-4D) was trained to predict an extent to which treatment with Trastuzumab resulted in progression-free survival. Progression-free survival was defined in this Example as the length of time during and after treatment during which a subject lives without progression of the disease (cancer). Notably, a positive output value or result indicated that treatment caused tumors to shrink or disappear. Inputs to the LSTM model included a set of laboratory features, which are shown along the x-axis in FIG. 7.

LIME was used to assess the influence that each of the input variables on outputs of the LSTM model. LIME is a technique for interpreting a machine-learning model and is described in Riberiro et al., “‘Why should I trust you?’ Explaining the predictions of any classifier” 97-101. 10.18653/v1/N16-3020 (2016), which is hereby incorporated by reference in its entirety for all purposes. Large absolute values indicate that a corresponding variable exhibited relatively high influence on outputs. Positive values indicate that the outputs are positively correlated with the variable, while negative values indicate that the outputs are negatively correlated with the variable.

As shown in FIG. 7, platelet counts were associated with the highest absolute importance metric. Thus, the LIME analysis suggests that high platelet counts are associated with positive response metrics. Meanwhile, high lactate dehydrogenase levels are associated with negative response metrics.

To test whether such a relationship was observed, data evaluating survival statistics associated with Trastuzumab treatment. Subjects were divided into two cohorts depending on whether they exhibited persistent low platelet count (LPC). Persistent LPC was defined as a platelet count that fell below an absolute threshold of 150,000 platelets/microliter or that dropped by 25% or more from a subject-specific baseline measurement with consecutive measurements below the threshold for at least 90 days. Of 1,095 subjects represented in the study, 416 (38%) were assigned to the persistent LPC cohort. Three study arms were conducted. In each study arm, Trastuzmab and one other agent (taxane, placebo or pertuzumab) was used for the treatment.

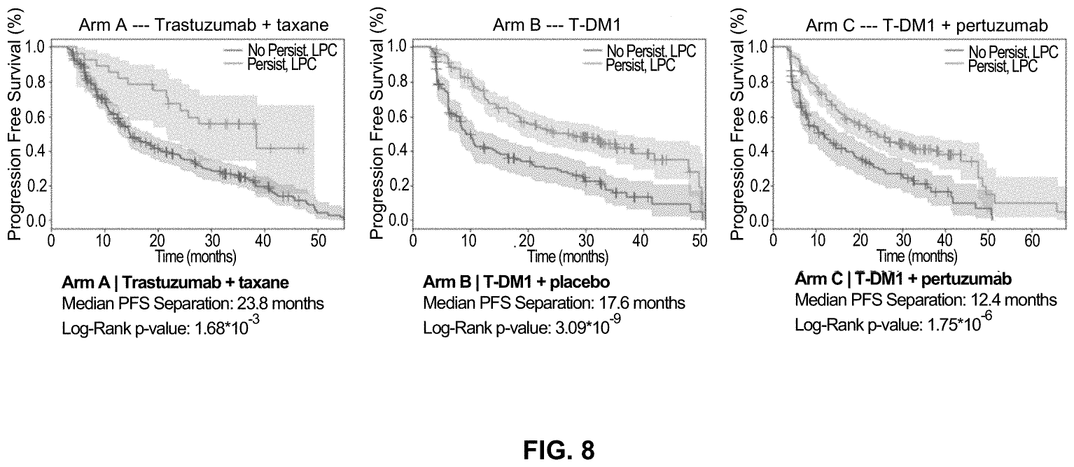

For each subject and for each of a set of time points, it was determined whether the subject had survived and was progression free. FIG. 8 shows the progression-free survival curves for the three study arms and two cohorts. Across all three arms, the LPC cohort showed statistically significant higher progression-free survival statistics as compared to the non-LPC cohort. Thus, it appears as though the LSTM model successfully learned that platelet counts are indicative of treatment responses.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart or diagram may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Specific details are given in the above description to provide a thorough understanding of the embodiments. However, it is understood that the embodiments can be practiced without these specific details. For example, circuits can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium”, “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method comprising:
accessing a multi-structure data set corresponding to an entity, the multi-structure data set including a temporally sequential data subset and a static data subset, the temporally sequential data subset having a temporally sequential structure in that the temporally sequential data subset includes multiple data elements corresponding to multiple time points, and the static data subset having a static structure;
executing a recurrent neural network (RNN) to transform the temporally sequential data subset into an RNN output;
executing a feedforward neural network (FFNN) to transform the static data subset into a FFNN output, wherein the FFNN was trained without using the RNN and without using training data having the temporally sequential structure;
determining an integrated output based on the RNN output, wherein at least one of the RNN output and the integrated output depend on the FFNN output, and wherein the integrated output corresponds to a prediction of an efficacy of treating the entity with a particular treatment; and
outputting the integrated output.

2. The method of claim 1, further comprising:
inputting, by a user, the multi-structure data or identifier of the entity; and
receiving, by the user, the integrated output.

3. The method of claim 1, further comprising:
determining, based on the integrated output, to treat the subject with the particular treatment; and
prescribing the particular treatment for the subject.

4. The method of claim 1, wherein:
the static data subset includes image data and non-image data;
the FFNN executed to transform the image data includes a convolutional neural network; and
the FFNN executed to transform the non-image data includes a multi-layer perceptron neural network.

5. The method of claim 1, wherein:
the temporally sequential data subset includes image data;
the recurrent neural network executed to transform the image data includes a LSTM convolutional neural network;
the multi-structure data set includes another temporally sequential data subset that includes non-image data;
the method further includes executing a LSTM neural network to transform the non-image data into another RNN output; and
the integrated output is further based on the other RNN output.

6. The method of claim 1, wherein:
the RNN output includes at least one hidden state of an intermediate recurrent layer in the RNN;
the multi-structure data set includes another static data subset that includes non-image data;
the method further includes executing another FFNN to transform the other static data subset into another FFNN output; and
the other FFNN output including a set of intermediate values generated at an intermediate hidden layer in the other FFNN.

7. The method of claim 1, wherein determining the integrated output includes executing an integration FFNN to transform the FFNN output and the RNN output to the integrated output, wherein each of the FFNN and the RNN were trained without using the integrated FFNN.

8. The method of claim 1, further comprising:
concatenating the FFNN output and a data element of the multiple data elements from the temporally sequential data subset, the data element corresponding to an earliest time point of the multiple time points to produce concatenated data;
wherein executing the RNN to transform the temporally sequential data subset into the RNN output includes using the RNN to process an input that includes:
the concatenated data; and
for each other data element of the multiple data elements that correspond to time points of the multiple time points subsequent to the earliest time points, the other data element; and
wherein the integrated output includes the RNN output.

9. The method of claim 1, further comprising:
generating an input that includes, for each data element of the multiple data elements from the temporally sequential data subset, a concatenation of the data element and the FFNN output;
wherein executing the RNN to transform the temporally sequential data subset into the RNN output includes using the RNN to process the input; and
wherein the integrated output includes the RNN output.

10. The method of claim 1, wherein:
the multi-structure data set includes:
another temporally sequential data subset that includes other multiple data elements corresponding to the multiple time points; and
another static data subset of a different data type or data structure than the static data subset;
the method further includes:
executing another FFNN to transform the other static data subset into another FFNN output;
executing a first integration neural network to transform the FFNN output and the other FFNN output to a static-data integrated output; and
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to a single hidden state of an intermediate recurrent layer in the RNN, the single hidden state corresponding to a single time point of the multiple time points; and
determining the integrated output includes processing the static-data integrated output and the RNN output using a second integration neural network.

11. The method of claim 1, wherein:
the multi-structure data set includes:
another temporally sequential data subset that includes other multiple data elements corresponding to the multiple time points; and
another static data subset of a different data type or data structure than the static data subset;
the method further includes:
executing another FFNN to transform the other static data subset into another FFNN output;
executing a first integration neural network to transform the FFNN output and the other FFNN output to a static-data integrated output;
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to multiple hidden states in the RNN, each of the multiple time points corresponding to a hidden state of the multiple hidden states; and
determining the integrated output includes processing the static-data integration output and the RNN output using a second integration neural network.

12. The method of claim 1, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the method further includes:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including a single hidden state of an intermediate recurrent layer in the RNN, the single hidden state corresponding to a single time point of the multiple time points, the other RNN output including another single hidden state of another intermediate recurrent layer in the other RNN, the other single hidden state corresponding to another single time point of the other multiple time points; and
concatenating the RNN output and the other RNN output;
wherein determining the integrated output includes processing the static-data integrated output and the concatenated outputs using a second integration neural network.

13. The method of claim 1, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the method further includes:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including multiple hidden states of an intermediate recurrent layer in the RNN, the multiple hidden states corresponding to the multiple time points, the other RNN output including other multiple hidden states of another intermediate recurrent layer in the other RNN, the other multiple hidden states corresponding to the other multiple time points; and
concatenating the RNN output and the other RNN output;
wherein determining the integrated output includes processing the static-data integrated output and the concatenated outputs using a second integration neural network.

14. The method of claim 1, further comprising:
executing another FFNN to transform the other static data subset into another FFNN output;
executing a first integration neural network to transform the FFNN output and the other FFNN output to a static-data integrated output; and
concatenating the RNN output and the static-data integrated output;
wherein determining the integrated output includes executing a second integration neural network to transform the concatenated outputs into the integrated output.

15. The method of claim 14, further comprising:
concurrently training the first integration neural network, the second integration neural network and the RNN using an optimization technique, wherein executing the RNN includes executing the trained RNN, wherein executing the first integration neural network includes executing the trained first integration neural network, and wherein executing the second integration neural network includes executing the trained second integration neural network.

16. The method of claim 1, further comprising:
accessing domain-specific data that includes a set of training data elements and a set of labels, wherein each training data element of the set of training data elements corresponds to a label of the set of labels; and
training the FFNN using the domain-specific data.

17. A method comprising:
transmitting, at a user device and to a remote computing system, an identifier corresponding to an entity, wherein, upon receipt of the identifier, the remote computing system being configured to, upon receipt of the identifier:
access a multi-structure data set corresponding to an entity, the multi-structure data set including a temporally sequential data subset and a static data subset, the temporally sequential data subset having a temporally sequential structure in that the temporally sequential data subset includes multiple data elements corresponding to multiple time points, and the static data subset having a static structure;
execute a recurrent neural network (RNN) to transform the temporally sequential data subset into an RNN output;
execute a feedforward neural network (FFNN) to transform the static data subset into a FFNN output, wherein the FFNN was trained without using the RNN and without using training data having the temporally sequential structure;
determine an integrated output based on the RNN output, wherein at least one of the RNN output and the integrated output depend on the FFNN output, and wherein the integrated output corresponds to a prediction of an efficacy of treating the entity with a particular treatment; and
transmit the integrated output; and
receiving, at the user device and from the remote computing system, the integrated output.

18. The method of claim 17, further comprising:
collecting at least part of multi-structure data using a medical imaging device or laboratory equipment.

19. Use of an integrated output in the treatment of a subject, wherein the integrated output is provided by a computing device executing a computational model based on a multi-structure data set corresponding to the subject to provide the integrated output, wherein:
the multi-structure data set includes a temporally sequential data subset and a static data subset, the temporally sequential data subset having a temporally sequential structure in that the temporally sequential data subset includes multiple data elements corresponding to multiple time points, and the static data subset having a static structure; and
executing the computational model includes:
executing a recurrent neural network (RNN) to transform the temporally sequential data subset into an RNN output; and
executing a feedforward neural network (FFNN) to transform the static data subset into a FFNN output, wherein the FFNN was trained without using the RNN and without using training data having the temporally sequential structure; and
wherein the integrated output corresponds to a prediction of an efficacy of treating the subject with a particular treatment.

20. A system comprising:
one or more data processors; and
a non-transitory computer readable storage medium containing instructions which, when executed on the one or more data processors, cause the one or more data processors to perform actions including:
accessing a multi-structure data set corresponding to an entity, the multi-structure data set including a temporally sequential data subset and a static data subset, the temporally sequential data subset having a temporally sequential structure in that the temporally sequential data subset includes multiple data elements corresponding to multiple time points, and the static data subset having a static structure;
executing a RNN to transform the temporally sequential data subset into an RNN output;
executing a FFNN to transform the static data subset into a FFNN output, wherein the FFNN was trained without using the RNN and without using training data having the temporally sequential structure;
determining an integrated output based on the RNN output, wherein at least one of the RNN output and the integrated output depend on the FFNN output, and wherein the integrated output corresponds to a prediction of an efficacy of treating the entity with a particular treatment; and
outputting the integrated output.

21. The system of claim 20, wherein:
the static data subset includes image data and non-image data;
the FFNN executed to transform the image data includes a convolutional neural network; and
the FFNN executed to transform the non-image data includes a multi-layer perceptron neural network.

22. The system of claim 20, wherein:
the temporally sequential data subset includes image data;
the RNN executed to transform the image data includes a LSTM convolutional neural network;
the multi-structure data set includes another temporally sequential data subset that includes non-image data;
the actions further include executing a LSTM neural network to transform the non-image data into another RNN output; and
the integrated output is further based on the other RNN output.

23. The system of claim 20, wherein:
the RNN output includes at least one hidden state of an intermediate recurrent layer in the RNN;
the multi-structure data set includes another static data subset that includes non-image data;
the actions further include executing another FFNN to transform the other static data subset into another FFNN output; and
the other FFNN output including a set of intermediate values generated at an intermediate hidden layer in the other FFNN.

24. The system of claim 20, wherein determining the integrated output includes executing an integration FFNN to transform the FFNN output and the RNN output to the integrated output, wherein each of the FFNN and the RNN were trained without using the integrated FFNN.

25. The system of claim 20, wherein the actions further include:
concatenating the FFNN output and a data element of the multiple data elements from the temporally sequential data subset, the data element corresponding to an earliest time point of the multiple time points to produce concatenated data;
wherein executing the RNN to transform the temporally sequential data subset into the RNN output includes using the RNN to process an input that includes:
the concatenated data; and
for each other data element of the multiple data elements that correspond to time points of the multiple time points subsequent to the earliest time points, the other data element; and
wherein the integrated output includes the RNN output.

26. The system of claim 20, wherein the actions further include:
generating an input that includes, for each data element of the multiple data elements from the temporally sequential data subset, a concatenation of the data element and the FFNN output;
wherein executing the RNN to transform the temporally sequential data subset into the RNN output includes using the RNN to process the input; and
wherein the integrated output includes the RNN output.

27. The system of claim 20, wherein:
the multi-structure data set includes:
another temporally sequential data subset that includes other multiple data elements corresponding to the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output; and
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to a single hidden state of an intermediate recurrent layer in the RNN, the single hidden state corresponding to a single time point of the multiple time points; and
determining the integrated output includes processing the static-data integrated output and the RNN output using a second integration neural network.

28. The system of claim 20, wherein:
the multi-structure data set includes:
another temporally sequential data subset that includes other multiple data elements corresponding to the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to multiple hidden states in the RNN, each of the multiple time points corresponding to a hidden state of the multiple hidden states; and
determining the integrated output includes processing the static-data integration output and the RNN output using a second integration neural network.

29. The system of claim 20, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including a single hidden state of an intermediate recurrent layer in the RNN, the single hidden state corresponding to a single time point of the multiple time points, the other RNN output including another single hidden state of another intermediate recurrent layer in the other RNN, the other single hidden state corresponding to another single time point of the other multiple time points; and
concatenating the RNN output and the other RNN output;
wherein determining the integrated output includes processing the static-data integrated output and the concatenated outputs using a second integration neural network.

30. The system of claim 20, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including multiple hidden states of an intermediate recurrent layer in the RNN, the multiple hidden states corresponding to the multiple time points, the other RNN output including other multiple hidden states of another intermediate recurrent layer in the other RNN, the other multiple hidden states corresponding to the other multiple time points; and
concatenating the RNN output and the other RNN output;
wherein determining the integrated output includes processing the static-data integrated output and the concatenated outputs using a second integration neural network.

31. The system of claim 20, wherein the actions further include:
executing another FFNN to transform the other static data subset into another FFNN output;
executing a first integration neural network to transform the FFNN output and the other FFNN output to a static-data integrated output; and
concatenating the RNN output and the static-data integrated output;
wherein determining the integrated output includes executing a second integration neural network to transform the concatenated outputs into the integrated output.

32. The system of claim 31, wherein the actions further include:
concurrently training the first integration neural network, the second integration neural network and the RNN using an optimization technique, wherein executing the RNN includes executing the trained RNN, wherein executing the first integration neural network includes executing the trained first integration neural network, and wherein executing the second integration neural network includes executing the trained second integration neural network.

33. The system of claim 20, wherein the actions further include:
accessing domain-specific data that includes a set of training data elements and a set of labels, wherein each training data element of the set of training data elements corresponds to a label of the set of labels; and
training the FFNN using the domain-specific data.

34. A computer-program product tangibly embodied in a non-transitory machine-readable storage medium, including instructions configured to cause one or more data processors to perform actions including:
accessing a multi-structure data set corresponding to an entity, the multi-structure data set including a temporally sequential data subset and a static data subset, the temporally sequential data subset having a temporally sequential structure in that the temporally sequential data subset includes multiple data elements corresponding to multiple time points, and the static data subset having a static structure;
executing a RNN to transform the temporally sequential data subset into an RNN output;
executing a FFNN to transform the static data subset into a FFNN output, wherein the FFNN was trained without using the RNN and without using training data having the temporally sequential structure;
determining an integrated output based on the RNN output, wherein at least one of the RNN output and the integrated output depend on the FFNN output, and wherein the integrated output corresponds to a prediction of an efficacy of treating the entity with a particular treatment; and
outputting the integrated output.

35. The computer-program product of claim 34, wherein:
the static data subset includes image data and non-image data;
the FFNN executed to transform the image data includes a convolutional neural network; and
the FFNN executed to transform the non-image data includes a multi-layer perceptron neural network.

36. The computer-program product of claim 34, wherein:
the temporally sequential data subset includes image data;
the RNN executed to transform the image data includes a LSTM convolutional neural network;
the multi-structure data set includes another temporally sequential data subset that includes non-image data;
the actions further include executing a LSTM neural network to transform the non-image data into another RNN output; and
the integrated output is further based on the other RNN output.

37. The computer-program product of claim 34, wherein:
the RNN output includes at least one hidden state of an intermediate recurrent layer in the RNN;
the multi-structure data set includes another static data subset that includes non-image data;
the actions further include executing another FFNN to transform the other static data subset into another FFNN output; and
the other FFNN output including a set of intermediate values generated at an intermediate hidden layer in the other FFNN.

38. The computer-program product of claim 34, wherein determining the integrated output includes executing an integration FFNN to transform the FFNN output and the RNN output to the integrated output, wherein each of the FFNN and the RNN were trained without using the integrated FFNN.

39. The computer-program product of claim 34, wherein the actions further include:
concatenating the FFNN output and a data element of the multiple data elements from the temporally sequential data subset, the data element corresponding to an earliest time point of the multiple time points to produce concatenated data;
wherein executing the RNN to transform the temporally sequential data subset into the RNN output includes using the RNN to process an input that includes:
the concatenated data; and
for each other data element of the multiple data elements that correspond to time points of the multiple time points subsequent to the earliest time points, the other data element; and
wherein the integrated output includes the RNN output.

40. The computer-program product of claim 34, wherein the actions further include:
generating an input that includes, for each data element of the multiple data elements from the temporally sequential data subset, a concatenation of the data element and the FFNN output;
wherein executing the RNN to transform the temporally sequential data subset into the RNN output includes using the RNN to process the input; and
wherein the integrated output includes the RNN output.

41. The computer-program product of claim 34, wherein:
the multi-structure data set includes:
another temporally sequential data subset that includes other multiple data elements corresponding to the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output; and
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to a single hidden state of an intermediate recurrent layer in the RNN, the single hidden state corresponding to a single time point of the multiple time points; and
determining the integrated output includes processing the static-data integrated output and the RNN output using a second integration neural network.

42. The computer-program product of claim 34, wherein:
the multi-structure data set includes:
another temporally sequential data subset that includes other multiple data elements corresponding to the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
generating an input that includes, for each time point of the multiple time points, a concatenated data element that includes the data element of the multiple data elements that corresponds to the time point and the other data element of the other multiple data elements that corresponds to the time point;
executing the RNN to transform the temporally sequential data subset into the RNN output includes using the RNN to process the input;
the RNN output corresponds to multiple hidden states in the RNN, each of the multiple time points corresponding to a hidden state of the multiple hidden states; and
determining the integrated output includes processing the static-data integration output and the RNN output using a second integration neural network.

43. The computer-program product of claim 34, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including a single hidden state of an intermediate recurrent layer in the RNN, the single hidden state corresponding to a single time point of the multiple time points, the other RNN output including another single hidden state of another intermediate recurrent layer in the other RNN, the other single hidden state corresponding to another single time point of the other multiple time points; and
concatenating the RNN output and the other RNN output;
wherein determining the integrated output includes processing the static-data integrated output and the concatenated outputs using a second integration neural network.

44. The computer-program product of claim 34, wherein:
the multi-structure data set includes:
another temporally sequential data subset having another temporally sequential structure in that the other temporally sequential data subset includes other multiple data elements corresponding to other multiple time points, the other multiple time points being different than the multiple time points; and
another static data subset of a different data type or data structure than the static data subset;
the actions further include:
executing another FFNN to transform the other static data subset into another FFNN output;
executing a first integration neural network to transform the FFNN output and the other FFNN output to a static-data integrated output;
executing another RNN to transform the other temporally sequential data subset into another RNN output, the RNN having been trained independently from and executed independently from the other RNN, the RNN output including multiple hidden states of an intermediate recurrent layer in the RNN, the multiple hidden states corresponding to the multiple time points, the other RNN output including other multiple hidden states of another intermediate recurrent layer in the other RNN, the other multiple hidden states corresponding to the other multiple time points; and
concatenating the RNN output and the other RNN output;
wherein determining the integrated output includes processing the static-data integrated output and the concatenated outputs using a second integration neural network.

45. The computer-program product of claim 34, wherein the actions further include:
executing another FFNN to transform the other static data subset into another FFNN output;
executing a first integration neural network to transform the FFNN output and the other FFNN output to a static-data integrated output; and
concatenating the RNN output and the static-data integrated output;
wherein determining the integrated output includes executing a second integration neural network to transform the concatenated outputs into the integrated output.

46. The computer-program product of claim 45, wherein the actions further include:
concurrently training the first integration neural network, the second integration neural network and the RNN using an optimization technique, wherein executing the RNN includes executing the trained RNN, wherein executing the first integration neural network includes executing the trained first integration neural network, and wherein executing the second integration neural network includes executing the trained second integration neural network.

47. The computer-program product of claim 34, wherein the actions further include:
accessing domain-specific data that includes a set of training data elements and a set of labels, wherein each training data element of the set of training data elements corresponds to a label of the set of labels; and
training the FFNN using the domain-specific data.

48. A method comprising:
receiving, a multi-structure data set corresponding to an entity, the multi-structure data set including a temporally sequential data subset and a static data subset, the temporally sequential data subset having a temporally sequential structure in that the temporally sequential data subset includes multiple data elements corresponding to multiple time points, and the static data subset having a static structure;
executing a recurrent neural network (RNN) to transform the temporally sequential data subset into an RNN output;
executing a feedforward neural network (FFNN) to transform the static data subset into a FFNN output, wherein the FFNN was trained without using the RNN and without using training data having the temporally sequential structure;
determining an integrated output based on the RNN output, wherein at least one of the RNN output and the integrated output depend on the FFNN output, and wherein the integrated output corresponds to a prediction of an efficacy of treating the entity with a particular treatment; and
outputting the integrated output;
determining, based on the integrated output, to treat the subject with the particular treatment; and
prescribing the particular treatment for the subject.
